(19) United States
(12) Patent Application Publication
(10) Pub. No.: US 2012/0208605 A1
(43) Pub. Date: Aug. 16, 2012

(54) MOBILE DEVICE POWER OPTIMIZATION WITH PERIPHERAL SENSORS WITH STANDARD INTERFACES

(75) Inventors: Nir Strauss, Haifa (IL); Ziv Kahana, Haifa (IL); Alon Paz, Zicron Yaakov (IL)

(73) Assignee: QUALCOMM Incorporated, San Diego, CA (US)

(21) Appl. No.: 13/026,117

(22) Filed: Feb. 11, 2011

(51) Int. Cl. H04W 52/02

(52) U.S. Cl. 455/574

(57) ABSTRACT

Methods and systems for using sensors on peripherals with mobile devices are disclosed. The peripherals connect with the mobile device using standard interfaces that are normally used for other functional devices. Using sensor data from the peripheral, the power consumption of the mobile device can be reduced.

### BACKGROUND

1. Background Field

The present invention relates to peripherals of mobile devices.

2. Relevant Background

Mobile devices, such as a cellular or other wireless communication device, personal communication system (PCS) device, personal navigation device (PND), Personal Information Manager (PIM), Personal Digital Assistant (PDA), portable video games, MP3 players, and portable computers, have become common place. The worldwide installed base of mobile devices likely exceeds several billions. Many mobile devices are capable of receiving wireless communication and/or navigation signals. The term mobile device is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, mobile device is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile device.”

FIG. 1 is a simplified block diagram of a typical mobile device 100. Mobile device 100 includes a control unit 110, a memory unit 120, a display unit 130, an audio unit 140, a user interface 150, a communication system 160, an antenna 170, and a standard interface 180. Generally, mobile device 100 uses display unit 130 to display images and videos and provides audio data through audio unit 140. User interface 150, which could be for example a keypad, keyboard, a touch screen, or joystick, is used to receive instruction from a user of mobile device 100.

For example, if mobile device 100 is a cell phone, user interface 150 could be a numeric keypad, audio unit 140 would include an audio circuits, a microphone and a speaker, and display unit 130 would generally be a small screen, such as a liquid crystal display (LCD) or an organic light emitting diode (OLED) display. If mobile device 100 were a portable video game, user interface 150 would likely be a joystick and several buttons, audio unit 140 would include audio circuits and a speaker, and display unit 130 would again be a small screen. In some mobile devices, display unit 130 and user interface 150 could be combined as a touch screen.

Communication system 160 uses antenna 170 to transmit and receive data from external transceivers. For example, if mobile device 100 is a cell phone, communication system 160 would be configured to interface with cellular base stations. If mobile device 100 is a portable computer, communication system 160 would likely be configured for Wi-Fi networks.

Many mobile devices also include standard interface 180. Standard interfaces are points of interconnection between mobile device 100 and peripherals, in which the physical, electrical and logical parameters adhere to an industry accepted definition. Standard interface 180 is often used as a memory interface to allow for memory expansion using standardized memory cards such as Secure Digital (SD) memory Cards, Micro-SD memory cards, or compact flash memory cards. Some mobile devices may include other standard interface ports such as Universal Serial Bus (USB), Subscriber Identity Module (SIM), Removable User Identity Module (RUIM), or Universal Asynchronous receiver/transmitter (UART). As technology advances additional standard interfaces are defined to incorporate the new technology.

As technology in other areas evolve, new features can be included into mobile devices. However, the large installed base of mobile devices can not make use of these new features. Hence there is a need for a method and system for adding new technology to conventional mobile devices.

### SUMMARY

Accordingly, the present invention provides low cost methods and systems for adding new technology to existing mobile devices. Specifically, new devices such as sensors or MEMS (Micro-Electro-Mechanical Systems) devices are embedded in peripherals using standard interface ports on the existing mobile devices.

Thus, a novel mobile system is formed by combining the mobile device having a first standard interface with a peripheral having a second standard interface, a functional device and a sensor. The second standard interface is connected to the first standard interface to allow the mobile device to access the sensor on the peripheral. In some aspects of the present invention data from the sensor is used to conserve power in the mobile device. For example, the mobile device could be configured to turn off a subsystem, such as a display, based on the orientation of the mobile device, which could be calculated using data from the sensor. In another aspect of the present invention, the performance of power consuming functions, such as connecting to a network, might be dependent upon data from the sensor.

The present invention will be more fully understood in view of the following description and drawings.

### BRIEF DESCRIPTION OF THE DRAWINGS

FIG. 1 is a simplified block diagram of a conventional mobile device.

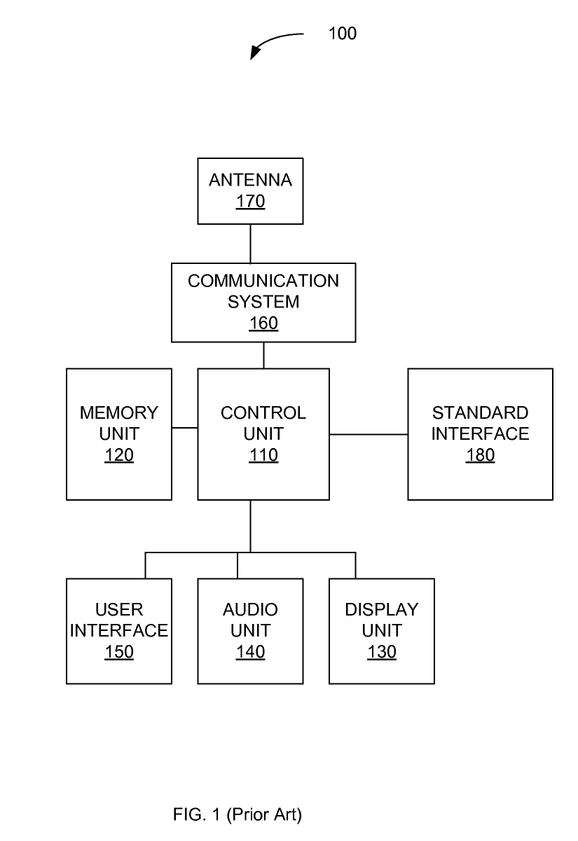

FIG. 2 is a simplified block diagram of a peripheral using a standard interface in accordance with one aspect of the present invention.

FIG. 3 is a flow diagram of a method to reduce power consumption in a mobile device in accordance with one aspect of the present invention.

FIG. 4 is a flow diagram of another method to reduce power consumption in a mobile device in accordance with one aspect of the present invention.

### DETAILED DESCRIPTION

As explained above, the installed base of mobile devices exceeds several billion. While new features are incorporated into newer models of mobile devices, users of pre-existing mobile devices must do without the new features or replace their mobile device with costly newer models. However, in accordance with the present invention, some new features can be used with existing mobile devices.

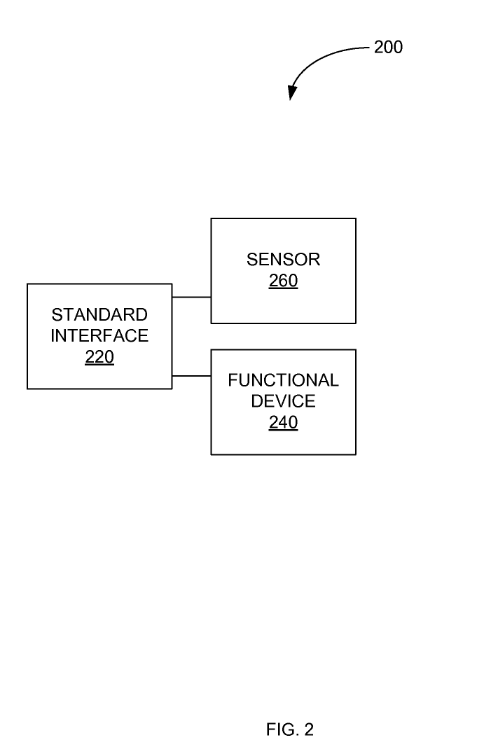

FIG. 2 is a simplified block diagram of a peripheral 200 in accordance with one aspect of the present invention. Peripheral 200 uses a standard interface 220, which is allows peripheral 200 to be used with mobile device 100 through standard interface 180. Peripheral 200 also includes a functional device 240 which performs the normal function typically used with standard interface 180 and standard interface 220. For example, if standard interface 180 and standard interface 220 are for Secure Digital (SD) memory cards, functional device 240 would be non-volatile memory. Peripheral 200 also includes a sensor 260 which can be used for various features as described below. Sensor 260 is usually a Micro-Electro-Mechanical System (MEMS) device, such as an accelerometer, a gyroscope, a compass, a pressure sensor, an altimeter, or other devices that can indicate movement or change in general environment. Sensor 260 is coupled to the mobile device through standard interface 220. In some aspects of the present invention sensor 260 may include multiple sensors. For clarity, the term “mobile system” is used herein to describe a mobile device that is attached to a peripheral with a sensor.

To maintain compatibility, with the standard interface, sensor 260 should operate and communicate with the mobile device without interfering with the operation of functional device 240. Thus, in accordance with one aspect of the present invention, when functional device 240 is a memory system, data from sensor 260 is mapped into memory addresses beyond the memory range of functional device 240. For example, if function device 240 is a one gigabyte memory, data from sensor 260 can be mapped to memory addresses above 1,073,741,824. Thus a mobile device can obtain sensor data by reading data from the sensor at the appropriate memory address.

In accordance with another aspect of the present invention, sensor 260 may detect when functional device is not being used and can push data to the mobile device using an interrupt system. In still other aspects of the present invention, standard interface 180 and standard interface 220 may support multiple devices and thus sensor 260 and functional device 240 can share standard interface 220 without issue. Universal Serial Bus (USB) is an example of an interface system that supports multiple devices. Generally, the mobile device is loaded with software that is aware of sensor 260. The software would be machine-readable c

In accordance with one aspect of the present invention, sensor 260 is used to reduce power consumption in a mobile device. Many mobile devices that communicate with external wireless networks, such as cell phones, expend power trying to connect to the network base stations of the wireless network. Typically, when a mobile device cannot connect to the network, the mobile device is configured to attempt to connect to the network at regular intervals. However, a very common reason the mobile device can not connect to the network is that the physical location of the mobile device is either out of range or somehow blocked from the network base stations. Thus, until the mobile device is moved from the current location, attempts to connect to the wireless network will fail. Furthermore, these attempts to connect to the wireless network needlessly consumes power. Thus, in accordance with one aspect of the present invention, certain power consuming functions are not performed until data from the sensor is read and analyzed to determine that the mobile device has moved.

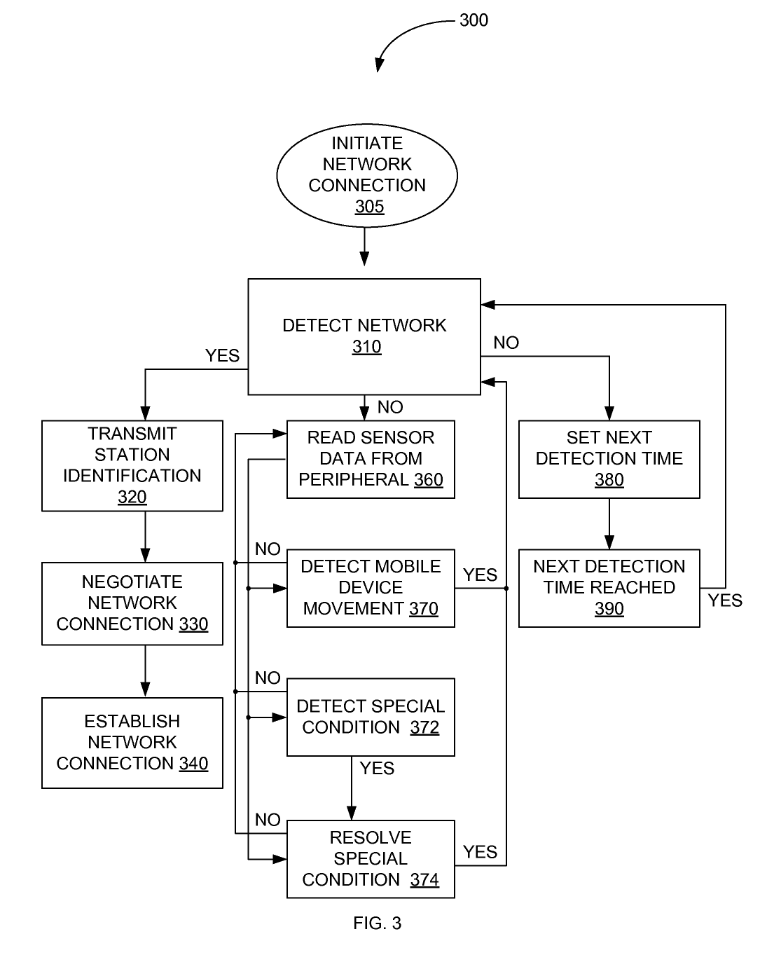

FIG. 3 is a flow diagram 300 of a method for reducing power consumption in a mobile device in accordance with one aspect of the present invention. The method of FIG. 3 begins when a mobile device attempts to connect to a wireless network in INITIATE NETWORK CONNECTION 305. The mobile device tries to detect the wireless network in DETECT NETWORK 310. Typically, the mobile device attempts to receive network identification signals from any base stations within range of the mobile device. In some aspects of the present invention, the mobile device may perform a deep fade search, and/or a search of a preferred roaming list. If the mobile device detects the wireless network, the mobile device transmits identification information about the mobile device to the wireless network in TRANSMIT STATION IDENTIFICATION 320. The mobile device then negotiates a network connection with the wireless network in NEGOTIATE NETWORK CONNECTION 330. After negotiations, the mobile device establishes a network connection in ESTABLISH NETWORK CONNECTION 340

IF the mobile device does not detect a network in DETECT NETWORK 310, the mobile device can use various operations to determine when to search for a network. A first operation could be based on movement while a second operation would be based on time. The operations can operate independently from each other. The movement based operation is available if a peripheral with a sensor (as shown in FIG. 2) is connected to the mobile device. Specifically, the mobile device reads sensor data from sensor 260, which is embedded in peripheral 200, in READ SENSOR DATA FROM PERIPHERAL 360. The mobile device uses the sensor data to detect whether the mobile device is moving (or has moved recently) in DETECT MOBILE DEVICE MOVEMENT 370. If the sensor detects movement, the mobile device again attempts to detection the wireless network in DETECT NETWORK 310. However, if no movement is detected, the mobile device conserves power by not attempting to detect the wireless network and instead reads the sensor data again in READ SENSOR DATA FROM PERIPHERAL 360. In some aspects of the present invention, the mobile device may idle for a short time if no movement is detected.

Movement of the mobile device may be inferred from sensor data from sensor 260. For example, if sensor 260 is an accelerometer, movement can be inferred when data from sensor 260 indicates that the accelerometer detected acceleration of the mobile device. If sensor 260 is a gyroscope, movement is inferred when the data from sensor 260 indicates a change in the orientation of the mobile device.

The mobile device may also use a time based delay operation for detection of a network. Specifically, when the network is not detected in DETECT NETWORK 310, the mobile state sets a next detection time N_T in SET NEXT DETECTION TIME 380. Next detection time N_T indicates when to perform the next network detection operation. Next detection time N_T can be a specific time of day, or could be a set amount of time (i.e. in 5 minutes). When next detection time N_T is reached in NEXT DETECTION TIME REACHED 390 the mobile device again attempts to detect the wireless network in DETECT NETWORK 310. In some aspects of the present invention, next detection time N_T is reset when a network detection operation is performed due to sensor data (i.e. in DETECT MOBILE DEVICE MOVEMENT 370). In addition, in some aspects of the present invention, if a peripheral having a sensor is connected to the mobile device, next detection time N_T may be set to a later time (or a greater amount) than if the peripheral with a sensor is not connected. Thus, having a peripheral with a sensor can reduce power consumption by reducing the number of network detection operations even when the phone is not moved.

Some aspects of the invention may include an optional special condition operation, which is based on detection of special conditions, to determine when to search for a network. Special conditions greatly reduces the chances of connecting to the network. Thus, during special conditions network detection operations would likely be futile and be a waste of power. The special condition operation can operate independently from the movement based operation (i.e. READ SENSOR DATA FROM PERIPHERAL 360 and DETECT MOBILE DEVICE MOVEMENT 370.) and the time based delay operation (i.e. SET NEXT DETECTION TIME 380 and NEXT DETECTION TIME REACHED 390). However in certain circumstances the special condition operation may override or modify the other movement based operation and the time based delay operation. Specifically, the sensor data read in READ SENSOR DATA FROM PERIPHERAL 360 is processed in DETECT SPECIAL CONDITION 372 to determine whether a special condition has occurred that reduces the chances of connecting to the network. If no special conditions are detected the movement based operation and the time based delay operation are allowed to operate normally. However, if a special condition is detected, the mobile device may override the movement based operation and/or the time based delay operation so that no attempts are made to connect to the network while the special condition exists. Alternatively, the mobile device may override the movement based operation while modifying the time based delay operation by increasing net detection time N_T.

Once a special condition is detected, the mobile device transitions to RESOLVES SPECIAL CONDITION 374. Based on the sensor data, the mobile device determines whether the special condition has been resolved. If the special condition is resolved, the mobile device again attempts to detection the wireless network in DETECT NETWORK 310. Furthermore, the movement based operation and time based delay operation are allowed to operate normally. However, if the special condition is still not resolved, the mobile device conserves power by not attempting to detect the wireless network and instead reads the sensor data again in READ SENSOR DATA FROM PERIPHERAL 360. In some aspects of the present invention, the mobile device may idle for a short time after determining that the special condition is not resolved.

As explained above, special conditions exist when the mobile device is unlikely to be able to connect to the network. Some examples of special conditions include, when the mobile device is in an underground structure (such as a parking garage, or a cave) or when the mobile device is in a tunnel. With regards to an underground parking garage, the special condition could be determined by diction of a prolonged descent. Such as riding down an elevator. Resolution of the special condition can be caused by a detection of a prolonged ascent. Detection of entering a tunnel can be detected when the sensor includes GPS abilities.

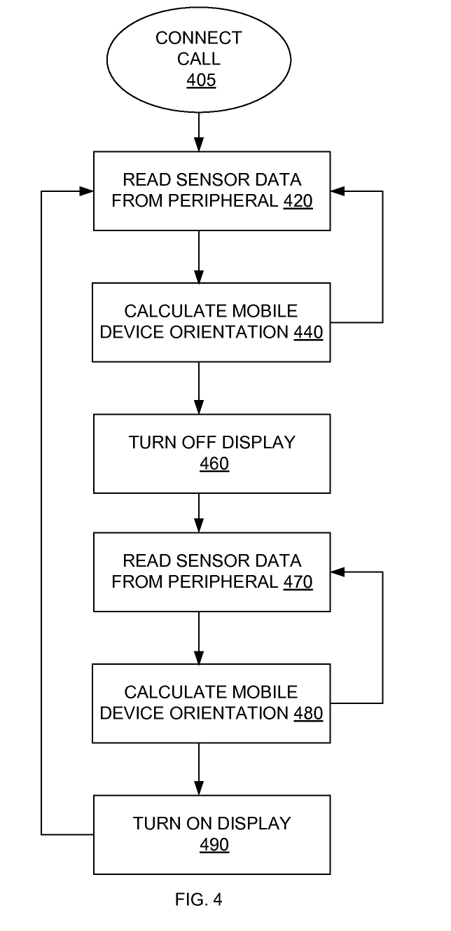

Another common technique to reduce power consumption in mobile devices is to turn off a subsystem, such as a display, when the subsystem is not needed. For example, in cell phones, the display is often turned off when no keypad entry is received after a fixed time interval. By using the embedded sensor in the peripheral, the mobile device can detect conditions to turn off the display more quickly and thus reduce power consumption. FIG. 4 is a flow diagram of another method for reducing power consumption in a mobile device in accordance with one aspect of the present invention. The method of FIG. 4 is geared for mobile devices that are used as cell phones. Furthermore, for the method of FIG. 4, sensor 260 could be a gyroscope or other similar device. Specifically, after a call connected, a user typically raises the phone to the user's ear at which time the display would not be viewable and thus can be turned off to conserve power.

The method of FIG. 4 begins when a mobile device connects a call through the wireless network in CONNECT CALL 405. After the call is connected, the mobile device reads sensor data from the sensor in the peripheral in READ SENSOR DATA FROM PERIPHERAL 420. Then, the mobile device calculates the orientation of the mobile device in CALCULATE MOBILE DEVICE ORIENTATION 440. If the orientation of the mobile device indicates that the mobile device is at the user's ear, the mobile device turns off the display in TURN OFF DISPLAY 460. Otherwise, the mobile device reads the sensor data from the peripheral in READ SENSOR DATA FROM PERIPHERAL 420. Some aspects of the present invention, enhances user experience by turning on the display when appropriate. For example, a user may need to see some data on the mobile device. Thus, as shown in FIG. 4, in some aspects of the present invention after the display is turned off in TURN OFF DISPLAY 460, the mobile device reads sensor data from the sensor in the peripheral in READ SENSOR DATA FROM PERIPHERAL 470. Then, the mobile device calculates the orientation of the mobile device in CALCULATE MOBILE DEVICE ORIENTATION 480. If the orientation of the mobile device indicates that the mobile device is held in a viewing orientation, the mobile device turns on the display in TURN ON DISPLAY 490. FIG. 4 is drawn for clarity, in actual implementation, some aspects of the present invention would combine READ SENSOR DATA FROM PERIPHERAL 420 and READ DATA FROM PERIPHERAL 470 and also combine CALCULATE MOBILE DEVICE ORIENTATION 440 and CALCULATE MOBILE DEVICE ORIENTATION 480.

In other aspects of the present invention, sensor 260 in peripheral 200 could be used for other purposes. In one aspect of the present invention, the sensor can be used as part of a user input system. For example, a sensor incorporating an accelerometer and a gyroscope can be used for playing video games.

The methodologies described herein may be implemented by various means depending upon the application. For example, these methodologies may be implemented in hardware, firmware, software, or any combination thereof. For an implementation involving hardware, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

Furthermore, the methodologies may be implemented with modules (e.g., procedures, functions, and so on) that perform the functions described herein. Any machine readable medium tangibly embodying instructions may be used in implementing the methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processing units to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

In the various aspects of the present invention, novel methods and systems have been described for integrating a sensor on a peripheral with a standard interface with existing mobile devices. The various aspects of the structures and methods of this invention that are described above are illustrative only of the principles of this invention and are not intended to limit the scope of the invention to the particular aspects described. For example, in view of this disclosure those skilled in the art can define other mobile devices, peripherals, sensors, interfaces and so forth, and use these alternative features to create a method, or system according to the principles of this invention. Thus, the invention is limited only by the following claims.

What is claimed is:

1. A method of reducing power consumption in a mobile device, the method comprising:
reading data from a sensor on a peripheral having a functional device through a standard interface; and
performing a network detection operation based on data from the sensor.

2. The method of claim 1, wherein the performing a network operation function based on data from the sensor further comprises:
detecting movement of the mobile device based on the data from the sensor; and
initiating the network detection operation when movement of the mobile device is detected.

3. The method of claim 2, further comprising idling the mobile device when movement of the mobile device is not detected.

4. The method of claim 2, wherein movement of the mobile device is inferred when acceleration of the mobile device is indicated in the data from the sensor.

5. The method of claim 2, wherein movement of the mobile device is inferred when a change in orientation of the mobile device is indicated in the data from the sensor.

6. The method of claim 1 further comprising performing a network detection operation when a next detection time is reached.

7. The method of claim 1, further comprising:
detecting a special condition; and
performing a network detection operation when the special condition is resolved.

8. The method of claim 7, further comprising inhibiting the performing a network detection operation based on data from the sensor when the special condition is detected.

9. The method of claim 7, wherein the special condition is that the mobile device is underground.

10. A mobile device comprising:
means for reading data from a sensor on a peripheral having a functional device through a standard interface; and
means for performing a network detection operation based on data from the sensor.

11. The mobile device of claim 10, wherein the means for performing a network operation function based on data from the sensor further comprises:
means for detecting movement of the mobile device based on the data from the sensor; and
means for initiating the network detection operation when movement of the mobile device is detected.

12. The mobile device of claim 11, further comprising means for idling the mobile device when movement of the mobile device is not detected.

13. The mobile device of claim 11, wherein movement of the mobile device is inferred when acceleration of the mobile device is indicated in the data from the sensor.

14. The mobile device of claim 11, wherein movement of the mobile device is inferred when a change in orientation of the mobile device is indicated in the data from the sensor.

15. The mobile device of claim 10, further comprising means performing a network detection operation when a next detection time is reached.

16. The mobile device of claim 10, further comprising:
means for detecting a special condition; and
means for performing a network detection operation when the special condition is resolved.

17. The mobile device of claim 16, further comprising means for inhibiting the means for performing a network detection operation based on data from the sensor when the special condition is detected.

18. The mobile device of claim 16, wherein the special condition is that the mobile device is underground.

19. A computer-readable medium including program code stored thereon, comprising:
program code to read data from a sensor on a peripheral having a functional device through a standard interface; and
program code to perform a network detection operation based on data from the sensor.

20. The computer-readable medium, wherein the program code to perform a network operation function based on data from the sensor further comprises:
program code to detect movement of the mobile device based on the data from the sensor; and
program code to initiate the network detection operation when movement of the mobile device is detected.

21. The computer-readable medium of claim 20, further comprising program code to idle the mobile device when movement of the mobile device is not detected.

22. The computer-readable medium of claim 20, wherein movement of the mobile device is inferred when acceleration of the mobile device is indicated in the data from the sensor.

23. The computer-readable medium of claim 20, wherein movement of the mobile device is inferred when a change in orientation of the mobile device is indicated in the data from the sensor.

24. The computer-readable medium of claim 19 further comprising program code to perform a network detection operation when a next detection time is reached.

25. The computer-readable medium of claim 19, further comprising:
program code to detect a special condition; and
program code to perform a network detection operation when the special condition is resolved.

26. The computer-readable medium of claim 25, further comprising program code to inhibit the program code to perform a network detection operation based on data from the sensor when the special condition is detected.

27. The computer-readable medium of claim 25, wherein the special condition is that the mobile device is underground.
